(19) United States
(12) Patent Application Publication
(10) Pub. No.: US 2019/0321263 A1
(43) Pub. Date: Oct. 24, 2019

(54) MEDICATION ADMINISTRATION GUIDE

(71) Applicant: BK2BK, Inc., Chatsworth, CA (US)

(72) Inventor: Kimber Westmore, Chatsworth, CA (US)

(21) Appl. No.: 15/957,750

(22) Filed: Apr. 19, 2018

(51) Int. Cl. A61J 7/04; B65D 75/36; B65D 75/54

(52) U.S. Cl. CPC A61J 7/04; B65D 75/367; A61J 2205/40; A61J 2205/30; B65D 75/54

(57) ABSTRACT

A medication administration guide having a card member with an elongated opening. A transparent housing with a plurality of pill receiving cells is affixed to the card member in the elongated opening. The guide has a closure flap positioned to enclose the individual cells after a representative pill have been placed in each. The closure flap has one edge permanently affixed to the card member adjacent the elongated opening and a second edge for being selectively affixed to the card member on the opposite side of the elongated opening to enclose the individual cells and contain the pills. Medication information is affixed adjacent to each well has a pill therein on the first side of the card member and contact information is affixed to the second side of the card.

### BACKGROUND OF THE INVENTION

This invention relates generally to an apparatus and method for verifying medication to be administered.

Medication errors cause at least one death every day in the United States and injure approximately 1.3 million people annually. A Food and Drug Administration (FDA) study of fatal medication errors found that the most common errors involving medications were related to the administration of an improper dose of medicine (41%) and administration of the wrong medication (14%). Almost half of the fatal medication errors occurred in people over the age of 60, who often take multiple prescription medications.

The task of administering medications continues to be a manual process which is subject to human error. Typically, a caregiver must read dosages and frequency of administration from prescription bottles giving rise to the risk of mistakes in the quantity, frequency and even identity of the medications to be administered. Caregivers and patients in home environments shoulder a substantial amount of responsibility in managing the administration of mediation which can result in medication errors. Common errors include taking the wrong dosage or quantity of pills, forgetting to take certain medications or doses, taking the medication at the wrong time, too many times a day, or not enough times a day, among other problems. For patients taking multiple medications a day or having medication regimes involving complex timing and administration factors, careful day-to-day management of medication administering lends itself to administering errors. These risks of error are compounded because the handoff of administering duties to new caregivers unfamiliar with the patient lack a ready means of acquiring the necessary administering information. Emergency admitting hospital personnel are often left to decipher second and even third hand information, poor instruction sets, and dosing ambiguity leading to delays and increased risks of erroneous medication administering. Also, as patients age, they are more apt to be prescribed more medications, and at the same time they begin losing the ability to manage tasks like taking medications, thus becoming a hazard to themselves or family due to medication prescription errors.

What is needed is a simple device and method that can be used by caregivers and patients for verifying that the proper medication is being administered and to facilitate accurate communication of medication administration directions.

### SUMMARY OF THE INVENTION

A medication administration guide for use by a patient caregiver in accurately administering pill or capsule medication to a patient includes a card member with a first side, a second side and an elongated opening. A transparent housing is affixed to the card member to span the elongated opening where the transparent housing has a plurality of individual open cells aligned along its length in the elongated opening. Each well is oriented to receive a representative pill or capsule from the set of pills or capsules to be periodically administered to the patient so that each representative pill or capsule is visually in the well to enable easy comparison and selection of the pills and capsules to be administered by the caregiver. The medication administration guide further includes a closure flap attached to the card member adjacent the well opening and positioned to selectively cover and enclose the representative pills or capsules in the individual open cells. The closure flap has a first flap edge permanently affixed to the card member along one side of the elongated opening adjacent the cells and a second flap edge with an adhesive strip and a protective cover on the adhesive strip. In operation, the once the representative pills or capsules have been placed in the well, the protective cover is removed exposing the adhesive which is then pressed against the surface of the card member on a second side of the elongated opening opposite the one side to cover the open cells and thereby contain and retain the representative pills and capsules in the cells during use by the caregiver.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a pictorial front view of the medication administration guide in accordance with the described embodiment.

FIG. 2 is a pictorial back view of the medication administration guide shown in FIG. 1.

FIG. 3 is a pictorial front view of an alternative embodiment of the medication administration guide.

### DETAILED DESCRIPTION

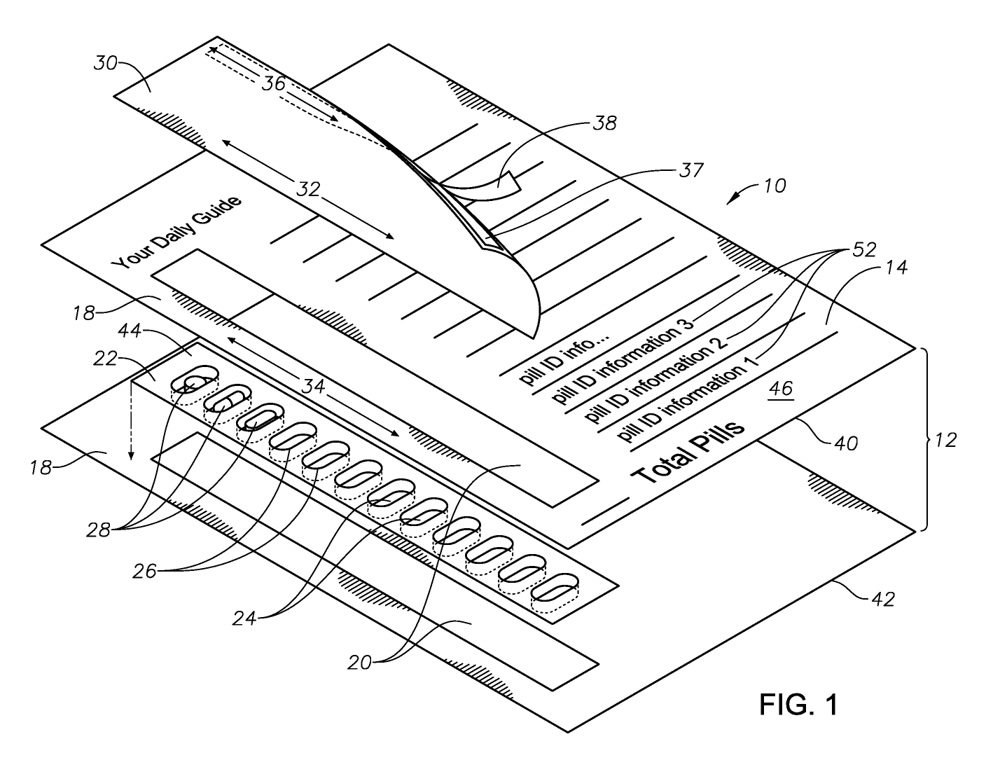

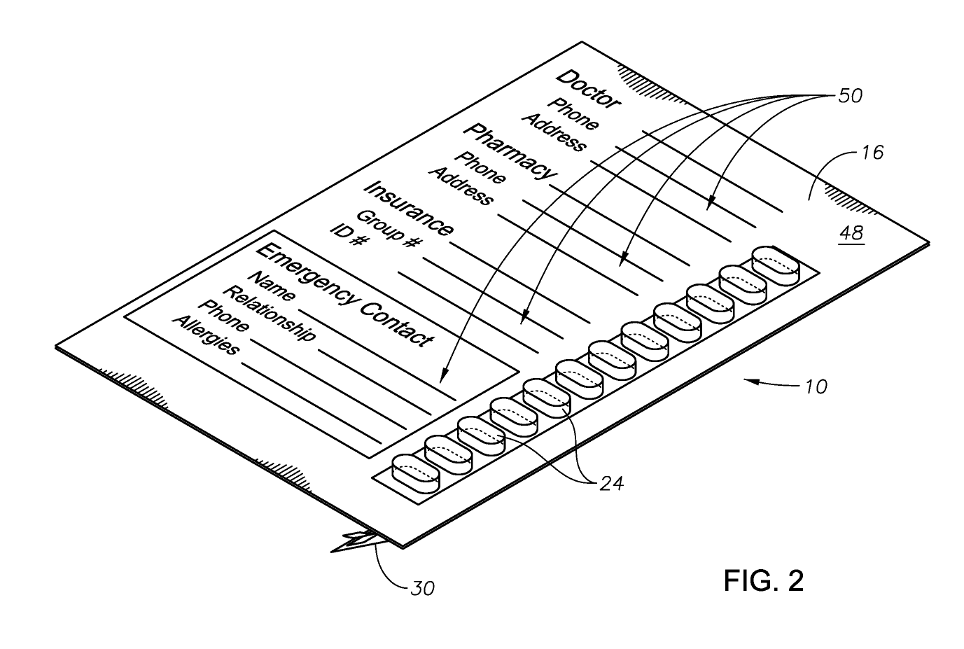

Referring to FIGS. 1 and 2, a representative medication administration guide 10 has a card member 12 which has a first side 14, a second side 16 and a first edge 18. Extending through the card member 10 is an elongated area which may be an opening 20 preferably adjacent to the first edge 18. Positioned in the elongated area 20 and attached to the card member 12 is a transparent member 22 which has a plurality of cells 24 therein which may be depressions or wells with openings 26 generally in the plane of the card member 12 for receiving a single representative pill or capsule 28 which are to be periodically taken by a patient. In one embodiment, the card member 12 can be made from a first card or ply 40 and a second card or ply 42 with the transparent member 22 having a peripheral flange 44 which is held between the first and second plies 40 and 42 for positioning and holding the transparent member 22 in the elongated opening 20. The first and second plies 40 and 42 may be glued or otherwise permanently bonded together to hold the transparent member in position in the elongated opening 20. Alternatively, card member may be a single ply with the transparent member glued, stapled or otherwise affixed to a top surface 46 or bottom surface 48 of the card member. Other alternative ways of integrating the member 22 and the card member will be apparent to one skilled in the art.

The medication administration guide 10 further has a closure member 30 positioned to cover and enclose the openings 26 of the individual cells 24 of the transparent member 22 after the representative pills or capsules 28 have each been individually placed in a different assigned one of the plurality cells 24. The closure member 30 has a first edge 32 which is juxtaposed along a first side 34 of the elongated opening 20. The closure member 30 may be a narrow strip or could be a ply coextensive with area of the card member 12 or integrally made as a transparent area in the card member 12 with the peripheral edges 44 of the transparent member 22 being attached to the top surface 46 or bottom surface 48 by any suitable means such as by adhesive between peripheral edge or flange 44 and one of the top or bottom surfaces 46 or 48. Of course in such an arrangement the pills or capsules would be positioned in their respective assigned cells 24 before the transparent member 22 is attached. Other options for providing or otherwise interconnecting the various elements of the medication administration guide 10 will be apparent to one skilled in the art.

In the embodiment shown in FIGS. 1 and 2, the first edge 32 of the closure member 30 may be fixed to the first side 34 by gluing, bonding, physical attachment such as by snaps or any other suitable means whereby the first edge 32 will be attached or otherwise affixed to the top surface 46 of card member 12 along the first side 34 adjacent to the plurality of cells 24. The closure member 30 further has a second edge 36 which may be selectively affixed to the surface 46 of the card member 12 opposite the first edge 32 for covering and enclosing the openings 26 of the individual cells 24 with the closure member 20. In one embodiment, the closure member 30 is transparent so that the pill or capsule 28 in each cell 24 can be clearly seen and identified by a caregiver when viewed from either side of card member 12.

The second edge 36 can be positioned and affixed to the surface 34 by incorporating an adhesive strip 37 along the length of the second edge 36 where the adhesive strip 37 may be covered by a protective strip 38 until use.

In use, the closure member 30 may be lifted to expose the open cells 24. The representative pill or capsule 28 for each cell 24 is placed in each cell 24 until a representative of each capsule or pill 28 to be taken by a patient at a given time has been placed in one of the cells 24. The protective strip 38 is then removed exposing the adhesive 37 along the second edge 36 with the second edge 36 pressed against the card member surface 46 so that the second edge 36 adheres to the card member surface 46 to enclose and retain the pills or capsules 28 in the cells 24. It will be appreciated that there are many other ways the above described arrangement can be achieved without departing from the invention. For example, any bonding or attachment means may be incorporated in place of the adhesive described in the above example. Likewise, the bonding or attachment means, and any necessary or associated protective strip, can be positioned on either the card member surface 46, on the closure member edge 36 or between the plies 40 and 42 of a multi-ply card member 12.

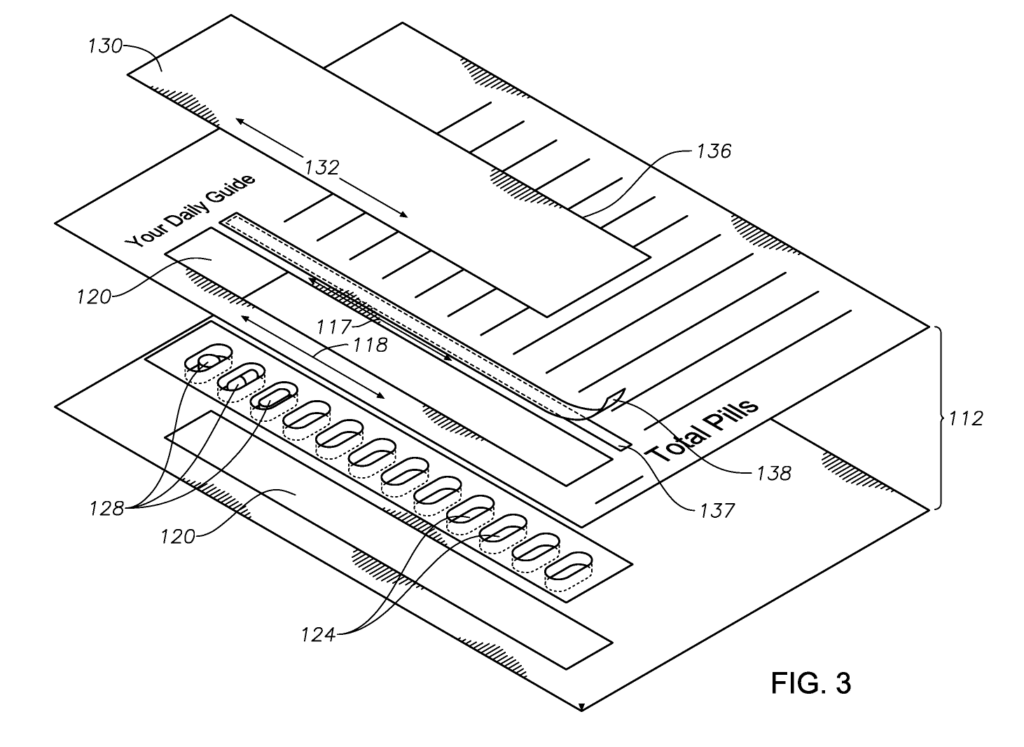

Referring to FIG. 3, one such alternative embodiment is for the adhesive and protective strip to be affixed to card member. Accordingly, an adhesive strip 137 is applied to an intermediate edge 117 of the card member 112 adjacent the elongated opening 120. When the pills or capsules 128 have been placed in the cells 124, the protective strip 138 is removed from the adhesive 137 on intermediate edge 117 and the second edge 136 of the closure member 130 is pressed into adhering relationship with the intermediate edge 117 to hold and retain the pills or capsules 128 in the cells 124. In the embodiment illustrated, it will be appreciated that the closure member first edge 132 will be affixed to the first edge 118 of the card member 112. Further, the closure member 130 will be made of a transparent plastic or film material.

Returning to FIG. 2, the second side 16 of card member 12 has affixed thereto contact information 50 that may be in the form of a sticker or may printed or written directly on the second side 16 of the card member 12. The contact information 50 may include insurance contact information, identification information, physician identification and contact information, patient identification information, pharmacy contact information, allergy information, emergency contact information or any other information pertinent to the care of the patient that an administering caregiver might need to know.

Referring to FIG. 1, the first side 14 of the card member 12 has affixed next to each well 24 having a pill or capsule 28 therein, identification information 52 regarding the pill or capsule 28 which may include the identity of the medication, the dosage amount, refill information, termination of administration information, the time of day for the administration or other data that would enable a care giver to quickly and accurately determine the particulars of the medication to be administered and to then be able to verify those particulars before administration. The result will be proper and consistent administration of patient medications with a lowered risk of mediation administration mistakes.

It will be appreciated that, although a limited number of embodiments of the invention have been described in detail for purposes of illustration, various modifications may be made without departing from the spirit and scope of the invention. For example, the items in the cells need not be limited to prescription medications but can also include vitamins, supplements or any other oral taken pills or capsules periodically taken by the patient and while the item is preferable a sample of the pill or capsule, it is possible to interpose a photo or other identifying representation of the pill or capsule in an individual pill or capsule identifier region in place of a well with a physical sample. Accordingly, the invention should not be limited except as explicitly recited in the appended claims.

1. A medication administration guide comprising:
a. A card member having a first side, a second side and a first edge, the card member having an elongated opening along and adjacent to the first edge;
b. A transparent insert juxtaposed with the elongated opening, the transparent insert having therein a plurality of individual cells, each well for receiving a representation of a single pill or capsule for visually identifying the representation of a single pill or capsule therein;
c. A closure member positioned for selectively covering and enclosing the individual cells.

2. The medication administration guide of claim 2 wherein the second edge has a card facing surface with adhesive thereon the adhesive having a removable protective strip thereon for being removed when the second edge is selectively affixed to the card member to enclose the cells.

3. The medication administration guide of claim 2 wherein the card member has an intermediate edge along the elongated opening and aligned with the second edge, the intermediate edge having thereon an adhesive and a protective strip thereon, the second edge being held in closure relationship against the second edge by the adhesive when the protective strip is removed.

4. The medication administration guide of claim 1 wherein the closure member is transparent.

5. The mediation administration guide of claim 1 wherein the second side of the card member is has affixed thereto contact information the contact information selected from the set of insurance identification information, physician identification information, pharmacy contact information, allergy information or emergency contact information.

6. The mediation administration guide of claim 1 wherein the first side of the card member has affixed thereto adjacent to each well, medication identification information corresponding to the representation of the pill or capsule in the adjacent well.

7. The medication administration guide of claim 1 wherein the card member further has affixed thereto an indication of the time the representation of the pill or capsule in the well is to be administered.

8. The mediation administration guide of claim 1 where in the card member further comprises a first ply and a second ply joined together with the transparent insert positioned in the elongated opening and affixed and held between the joined together between the first and second plies.

9. A method of providing a guide for medication administration to a patient comprising the steps of:
a. Preparing a card member having a first side, a second side, a transparent region with a plurality of individual pill or capsule representation receiving regions and a closure member for selectively enclosing the representation receiving regions;
b. Inserting a selected individual pill or capsule representation to be regularly taken by a patient into each individual pill or capsule representation receiving regions until an individual pill or capsule representation to be regularly taken is visible in one of the or the representation receiving regions;
c. Adhesively affixing the closure member across the representation receiving regions to enclose and contain the plurality of pills or capsules representations, and
d. Affixing medication identifying information on the card member first side adjacent to each individual pill or capsule representation receiving regions.

10. The method of claim 10 further comprising the step of affixing medication administering directions on the card member.

11. The method of claim 10 further comprising affixing contact information to the card member.

12. A medication administration guide comprising:
a. A card member having a first side, a second side, the card member having an elongated region therein;
b. An identifier member juxtaposed with the elongated region, the identifier member having therein a plurality of visual pill or capsule identifier regions, each such region for receiving a visual pill or capsule identifier for enabling the single pill or capsule identifier to be visually identified.

13. The medication administration guide of claim 13 wherein the identifier member is transparent with a plurality of cells for receiving a visual representation of a pill or capsule, the mediation administration guide further comprising a closure member positioned to selectively cover and enclose the individual representation of a pill or capsule, the closure member affixed to the card member to cover and enclose the individual cells with the closure member.

14. The medication administration guide of claim 14 wherein closure member is selectively affixed to the card member using adhesive.

15. The medication administration guide of claim 14 wherein the closure member is transparent.

16. The mediation administration guide of claim 13 wherein the first side of the card member has affixed thereto adjacent to each pill or capsule identifier region, medication identification information corresponding to the pill or capsule represented in the identifier region.

17. The mediation administration guide of claim 13 wherein the second side of the card member has affixed thereto contact information, the contact information selected from the set of insurance identification information, physician identification information, pharmacy contact information, allergy information or emergency contact information.

18. The mediation administration guide of claim 14 wherein the second side of the card member has affixed thereto contact information, the contact information selected from the set of insurance identification information, physician identification information, pharmacy contact information, allergy information or emergency contact information.
